(19) United States
(12) Patent Application Publication
(10) Pub. No.: US 2004/0125136 A1
(43) Pub. Date: Jul. 1, 2004

(54) Provision of services through a display system

(76) Inventor: Jukka Wallenius, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/330,547

(22) Filed: Dec. 30, 2002

(51) Int. Cl. G09G 5/00

(52) U.S. Cl. 345/764

(57) ABSTRACT

The invention relates to the use of services in a communication system which includes user-operated mobile terminals. In order so that the capabilities of a large display can be used in connection with a normal service session between a mobile terminal and a service application, service objects are displayed on a screen of a display unit external to a mobile terminal. When the user selects at least one object on the screen, selection parameters are defined which describe the selection. Based on the selection parameters, service-related information is further determined. The service-related information includes at least a resource identifier, which refers to a location of the service application in the network. A service request is then sent to the location, where new service content, which is to be transmitted to the mobile terminal, is determined on the basis of the request.

### FIELD OF THE INVENTION

The invention relates generally to the provision of services in a communication system in which mobile terminals are used. More particularly, the invention relates to the provision of services through a display system external to the mobile terminals. The invention further concerns such a display system, which typically includes a public display unit which is large when compared to the size of the display of a mobile terminal. From the point of view of a user, the invention relates to the wireless access and/or use of services through such a display system.

### BACKGROUND OF THE INVENTION

The current development towards truly mobile computing and networking has brought on the evolution of various access technologies which also provide the users with access to the Internet when they are outside their own home network. The first public communication network which provides truly ubiquitous World Wide Web (WWW) access is the Global System for Mobile Communications (GSM)-based mobile telephone network.

From the point of view of many service applications, however, the small size of a mobile terminal and particularly the small size of its display, poses a problem for many services provided in the network. The problem concerns especially many mobile-commerce (m-commerce) applications, since the ability to provide the customer with a high quality visual image of the object for purchase is vital for the success of such applications. The object for purchase can be a physical product, such as a piece of clothing, or a digital artifact, such as a map presented on the display of the mobile terminal.

The need to provide visual images with a quality higher than what can be produced by a common mobile terminal has led to the development and use of display systems based on large, public displays. These displays allow WWW access for people in public areas, such as airports, convention centers, railway stations, or shopping malls.

The article “WebWall—An Architecture for Public Display WWW Services” by A. Fersha, G. Kathan, and S. Vogl, at the website http://www2002.org/CDROM/alternate/701 (visited in November 2002), describes a system in which a large, public display communicates with the mobile terminals operated by users. The terminals (i.e. the users) interact with service objects presented on the screen of the display by passing messages and/or commands through the access modules of the display system. The display system supports a variety of service classes. Examples of the service classes mentioned in the article are:

note service, in which notes can be posted on the display to be viewed by everyone in the vicinity of the display,

polling service, in which an opinion on a desired issue can be solicited from a group located in the vicinity of the display, and

auction service, in which the users can bid for an item on sale, such as a car, being presented on the screen.

The above system is thus mainly intended for group and community communication and interaction through the shared display.

However, from the point of view of some service applications, such as the above-mentioned m-commerce applications, a less sophisticated system is also desirable, i.e. a system which assists the user during his or her conventional service session by complementing the limited ability of the mobile terminal to present visual images. It is an objective of the present invention to devise such a system.

### SUMMARY OF THE INVENTION

The objective of the invention is to devise a new mechanism for Web browsing. The mechanism allows the user to temporarily utilize the capacity of a large, high quality display for accessing and/or using network-based services.

In the display system of the present invention, a large, public display is located so that subscribers using mobile terminals, such as mobile phones, can move in the vicinity of the display in order to access and use services through the display. The display is provided with a media player and a repository/database for metadata describing the media content. When the media, such as a video clip, presenting a service is played or shown on the display, the user selects at least one point on the screen by touching the point, for example. In response to this, the display system first determines selection parameters which describe the selection event, such as the rectangular coordinates of the selected point(s) and the moment of selection. On the basis of the selection parameters, the display system then determines the service-related information corresponding to the selection parameters in question. This is performed on the basis of metadata which enables the mapping of the selection parameters to the service-related information by describing the relationship between the parameters and the information. The service-related information includes a service or resource identifier referring, directly or indirectly, to the location of the corresponding service application in the network. The service-related information may further include one or more service parameters. The state of the mobile terminal's browser is then updated by transmitting a service request to the location and defining the new content to be transmitted to the mobile terminal. The new content is defined on the basis of the information contained in the service request. The service request typically includes both the selection parameters and the service-related information (i.e. the resource identifier together with the possible service parameters). In an alternative embodiment, the service request may contain only the resource identifier used to route the request to the service application in question. The information which the display system transmits to the communication system therefore includes at least the resource identifier, but typically also the selection parameters, as well as the service parameters if the service parameters are determined.

Thus one aspect of the invention is the provision of a method for providing services in a communication system including user-operated mobile terminals, the method includes the steps of:

displaying information concerning a service on the screen of a display unit external to a mobile terminal, the information including service objects from which a user can select at least one;

in response to a selection made by a user, defining selection parameters describing the selection;

based on the selection parameters defined, determining service-related information, the service-related information including at least a resource identifier referring to the location of the service in the communication system;

transmitting a service request to the location;

forming new service content on the basis of the service request; and

transmitting the new service content to the mobile terminal.

In another aspect the invention provides a display system for a communication system including user-operated mobile terminals, the display system includes:

a display unit for displaying information concerning a service provided in the communication system, the information including service objects from which a user can select at least one;

user-operated selection means for selecting at least one service object;

first determination means, responsive to the selection means, for determining selection parameters which describe a selection made by a user;

second determination means for determining service-related information corresponding to the selection parameters, the service-related information including at least a resource identifier referring to a certain location in the communication system; and

transmission means for transmitting the service-related information to the communication system.

The information defined in the display system can be transmitted to the corresponding service application via the mobile terminal, via a push agent located in the communication system, or even directly. The optional service parameters may include data which does not describe the actual selection event, such as the geographical location of the display system.

By means of the solution of the invention, the capacity of a large high quality display is easily available to a user in connection with his/her service session, whenever the quality of visual information required is beyond the capabilities of the mobile terminal. Moreover, the system is easy to use as it requires a simple pointing action only.

Other features and advantages of the invention will become apparent through reference to the following detailed description and accompanying drawings.

### BRIEF DESCRIPTION OF THE DRAWINGS

In the following, the invention and its preferred embodiments are described more closely with reference to the examples shown in FIGS. 1 to 6 in the appended drawings, wherein:

FIG. 1 illustrates a display system according to the present invention;

FIG. 2 illustrates the basic operation of the display system in connection with a selection event;

FIG. 3 illustrates a typical network environment, in which the display system is used;

FIG. 4 is a flow diagram illustrating the operation of the mobile terminal in the vicinity of an external display;

FIG. 5 illustrates the message exchange in a further embodiment of the invention; and

FIG. 6 illustrates a further embodiment of the display system of the invention.

### DETAILED DESCRIPTION OF THE INVENTION

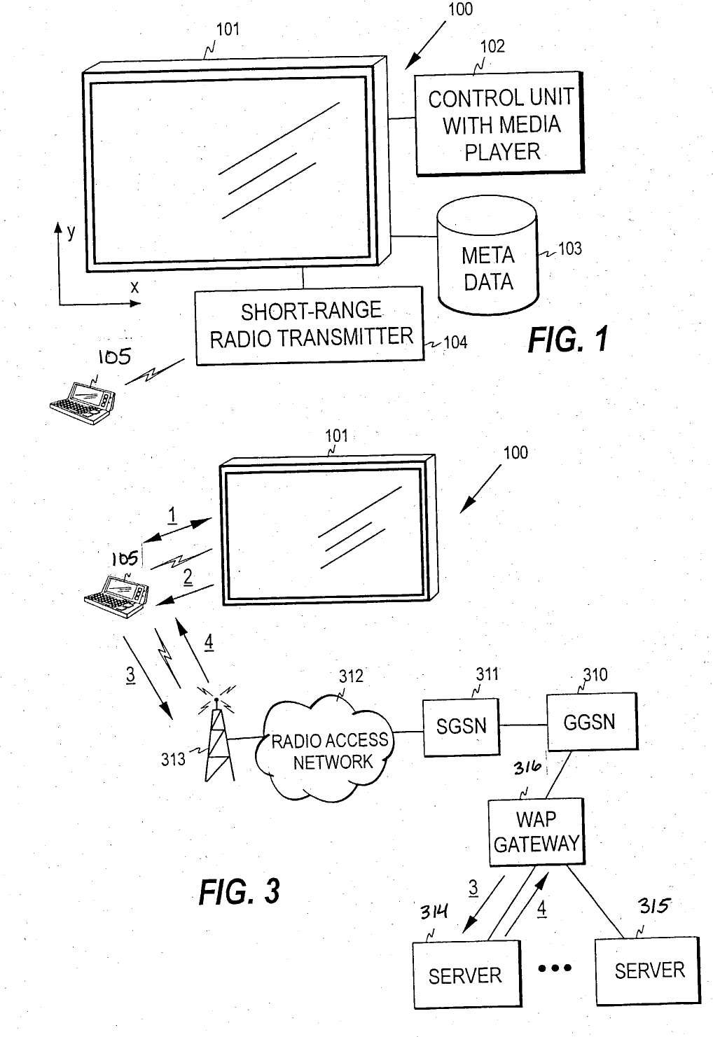

FIG. 1 illustrates a display system 100 according to the invention. A large display unit 101 is located in public premises, such as at an airport or in a convention center. The display unit is controlled by a control unit 102 provided with a media player for playing media content, such as a video stream, on the screen of the display, and possibly also synchronized audio information through the loudspeakers of the display unit. The information presented through the display unit describes services offered to mobile users moving in the vicinity of the display unit. If the display system is at an airport, the media player may play a video advertising the local hotels, for example. The media content, which may be in different known formats, can be on a separate media carrier, such as a DVD or hard disc, residing in conjunction with the media player. As described below, the media content can also be downloaded from the network to which the display system is connected.

The display unit preferably includes a touch-sensitive screen so that the user of a mobile terminal 105 can select a service object on the screen by touching the service object with his or her finger, for example. The physical display may be implemented by various known display technologies, including polymer LCDs, plasma displays, projectors, or CRTs, for example. Touch sensitivity is either a built-in property of the display or the display is provided with an additional touch-sensitive overlay, i.e. a conventional display can be made touch-sensitive by attaching a touch-sensitive overlay on top of the screen.

The mobile terminal 105, or alternatively the display unit 101, may also be provided with an adjunct pointer device with which the user can point at the desired points on the screen. As discussed below, a separate pointer device is advantageous when the identity of the mobile terminal needs to be transmitted to the display system. The pointing may even be implemented without manual contact with the screen, for example, through optical pointing systems which enable the display system to detect on the screen the position of the device output, such as a narrow beam.

Thus, regardless of the pointing system used, the display system should be able to detect the position of the selected points on the screen. In response to the selection made by the user, the control unit determines selection parameters which describe the selection event. These selection parameters preferably include the rectangular coordinates (i.e. x and y coordinates) of each of the points selected and the moment corresponding to the selection event.

The display system further includes a data repository 103, which includes metadata in XML format, for example, describing the relationship between the selection parameters and certain service-related information which is used to locate the corresponding service application in the communication system. The service-related information includes at least a resource identifier referring to the location of the corresponding service application in the communication system. The service-related information may further include various service parameters which can be used by the corresponding service application to determine the content to be transmitted to the mobile terminal.

The display system is further provided with a transmitter 104 for transmitting the service-related information, and possibly also the selection parameters, to the mobile station of the user who made the selection. This transmitter, which is responsive to the function of determining the service-related information, preferably, comprises a short-range radio transmitter so that only a mobile terminal in the vicinity of the display can receive the transmission from the display system. The transmitter may also be an infrared transmitter.

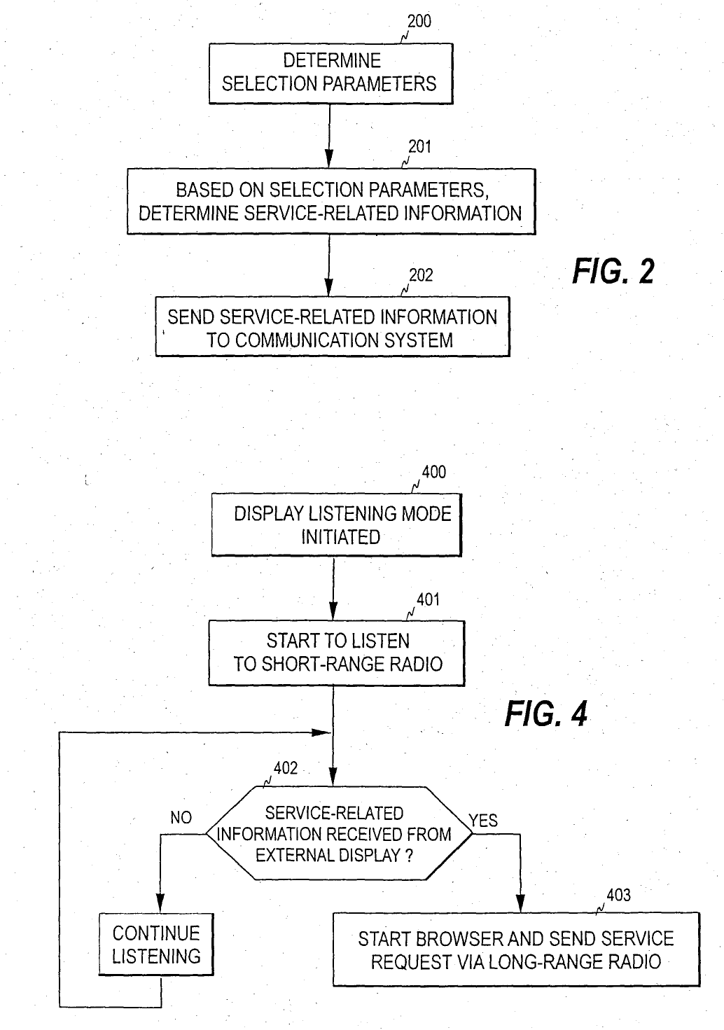

FIG. 2 illustrates the basic operation of the display system when the user touches the screen. First, the control unit determines the selection parameters which describe the selection event (step 200). It is assumed in this context that the selection parameters consist of a triplet containing the x and y coordinates of the touching point and the touching moment T. Secondly, the control unit uses the metadata to map the service parameters, i.e. the triplet (x, y, T), to the service-related information (step 201). As mentioned above, this service-related information includes at least one resource identifier, such as the URI (Uniform Resource Identifier), referring to the service application which corresponds to the service object(s) touched. As also indicated above, the service-related information may further include various service parameters, which can be used by the service application to determine the content to be transmitted to the mobile terminal 105. The service parameters may also include instructions to be given to the recipient party, e.g. instructions for the starting of the service session in the mobile terminal 105. Thirdly, the display system transmits the service-related information to the communication system (step 202). As discussed below, the information can be transmitted to the mobile terminal, to an agent in the network, or to the service itself. Prior to its transmission, the information may be modified or filtered, or additional information can be inserted, such as the geographical location of the display system. The information which the display system transmits to the communication system, thus, includes at least the resource identifier, but typically also the selection parameters, as well as the service parameters, providing the service parameters are determined.

In order to map the service parameters, i.e. the triplet(s) (x, y, T), to the service-related information, the control unit may operate so that it goes through the metadata with respect to each service object and determines whether the selection parameters corresponding to the point touched belong to the spatio-temporal region of the object. In the metadata, a spatio-temporal region can thus be associated with each service object shown on the screen. The region associated with a particular object is preferably defined as the coordinates of the outermost points of the object and as the period of validity of the coordinates. If the selection parameters corresponding to the point touched are found to be within the region of a particular service object, the service-related information associated with that object is returned to the mobile terminal.

FIG. 3 illustrates a typical network environment where the mechanism of the invention can be applied. Here, the mechanism is used to initiate a service session, during which the user downloads content or resources from a content server. It is assumed here that the display system 100 according to FIG. 1 (not shown in full in FIG. 3) plays a service video in which various services located at servers 314 to 315 are advertised. It is further assumed in FIG. 1 that the servers providing services are Wireless Application Protocol (WAP) servers connected through one or more WAP gateways 316 to a GPRS (General Packet Radio Service) network including a Gateway GPRS Support Node (GGSN) 310 and a Serving GPRS Support Node (SGSN) 311. The latter connects the GPRS core network to a Radio Access Network (RAN) 312 including a plurality of base stations 313 with which the mobile stations communicate through a radio interface. The user is thus a subscriber in a mobile communication system, such as the GSM or UMTS system, while the terminal is typically a mobile phone. Below, the mobile communication system is also termed the long-range radio system, in contrast to the short-range system used between the display system and the mobile terminal.

FIG. 3 shows the steps of the method of the invention with arrows identified by underlined numbers. It is assumed here that the selection parameters include the above-mentioned triplet. In other words, when determining the new content to be transmitted to the mobile terminal, the triplet is used as an input at the location indicated by the URI.

When the user notices an interesting service on the screen, he or she touches the screen at the point where the corresponding service object appears (step 1). The display system then determines the x and y coordinates of the touching point, as well as the touching moment T, and uses the metadata to map the triplet (x, y, T) to the URI of the service. The display system then transmits the URI and the triplet to the mobile terminal (step 2) through the short-range radio transmitter. Upon receiving the message from the display, the mobile terminal starts a browser, such as a WAP browser, and sends a service request to the network (step 3). The service request includes the URI (as an address) and the triplet, and possibly also an identifier identifying the user or the mobile terminal in question. It is assumed in this example that the URI refers to a service application residing at server 314, whereby the request is routed to the server. Using the data (i.e. the triplet) received in the request and the metadata stored at server 314, the service application forms a response page which is then sent to the mobile terminal (step 4). If the triplet and the metadata indicate that the user touched an image of a hotel room displayed on the screen, for example, the page may contain further information about the rooms of that type, such as price and availability. The user may then submit further information, such as the reservation dates and/or credit card information. The metadata stored at the server thus allows the triplet to be mapped to the content to be transmitted.

Depending on the service in question, the remaining service session may include a different number of interactions between the mobile terminal and the server providing the services. In view of the actual invention, the nature of the remaining steps is not essential, since the display system no longer participates in the session, but the session continues in a known manner. Various additional functionalities, such as charging functionalities, can also be combined with the service provision mechanism in a known manner.

FIG. 4 illustrates the operation of the mobile terminal in the vicinity of an external display system. When detecting an external display system presenting interesting information, the user may activate a display listening mode, in which the mobile terminal starts to listen to the short-range radio transmitter of the display system (steps 400 and 401). This may be implemented by clicking the corresponding icon(s) on the display of the terminal, for example. The detection of the display system may also be automatic, whereby upon the detection of an external display system, the mobile terminal opens a window which informs the user about the display system and which includes a menu through which the user may activate the display listening mode. In order to save power, it is advantageous that the mobile terminal does not listen to the long-range radio system while in the display listening mode. The user then touches the desired points on the screen of the external system, whereafter the display system returns to the mobile terminal the service-related information and the possible parameters (step 402/yes). Upon receiving this information, the terminal starts a browser which initiates a service session with the service application to which the URI refers (step 403).

The display system may also be authenticated in order to verify the identity of the display system prior to the reception of information from the display system. This can be implemented by known authentication methods.

As is obvious from the above, the mobile terminal 105 of the above example is provided with reception means which identify the messages transmitted by the external display systems, as well as the data carried by the messages. The messages are preferably provided with identifiers which indicate that the message originates from an external display system. These identifiers may even identify the particular display system transmitting the message. Furthermore, the mobile terminal is provided with means for initiating a service session with the service application referred to by the service identifier (URI) received from the external display system.

If it is possible for the display system to have several essentially simultaneous users, the display system must be able to differentiate between the mobile terminals. In this case, the above-mentioned pointing device can be such, for example, that an identifier is transmitted when the pointing device touches the screen. However, in a basic embodiment of the display system only one user uses the display at a time. In this case the mobile terminal can start listening to the display after the user has specifically activated the listening mode, which can be carried out by means of the terminal menus or by pressing a button, for example. This kind of activation of the listening mode is advantageous also in terms of power savings, as the terminal starts to listen to the short-range radio after the user specifically allows it. Furthermore, it protects the terminal from errors caused by other users of the display system.

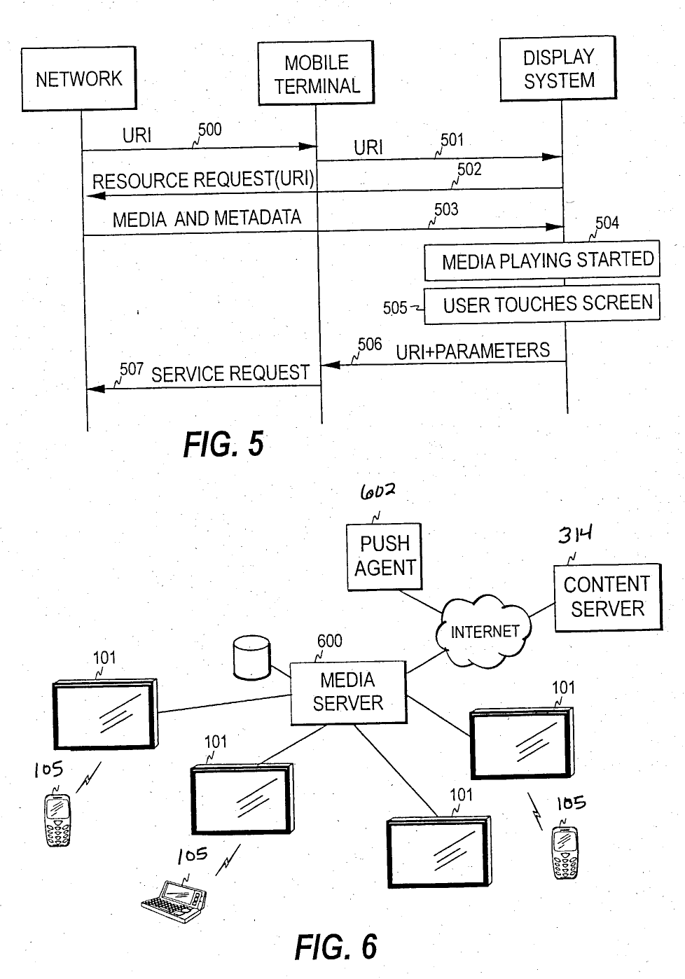

In the above examples, the initiative to utilize the external display system is based on the detection by the user of an interesting service on the external display, even if the mobile terminal automatically detects the presence of an external display system in its proximity. FIG. 5 illustrates another embodiment in which the initiative to utilize an external display comes from the service itself. When browsing WWW content, such as WML or XHTML documents, the user may select a service application which utilizes external display systems. When clicking on the link to such a service, the mobile terminal receives (step 500) a message including a URI referring to the location of the corresponding service application. The message received from the network includes an identifier, such as a meta tag, which indicates that an external display is available in connection with this service. When detecting the identifier, the mobile terminal forwards the message to a nearby display system (step 501). If the URI is such that the display system does not have the corresponding media content and metadata, the display system sends a service request to the location referred to by the URI (step 502). In response to this request, the display system receives the media content and the corresponding metadata from the service application (step 503). The display system then starts to play the media content received for the user (step 504). When the user touches the screen (step 505), the display system determines the selection parameters and the service-related information in the above-described manner. The display system then sends (step 506) the parameters (such as the URI and the triplet) through the short-range radio transmitter to the mobile terminal, which then sends (step 507) a service request to the address indicated by the URI, as discussed above.

In the above embodiment the display system is thus equipped with an Internet connection. Furthermore, the mobile terminal must be equipped with a transmitter for transmitting to the display system the URI received from the network. This transmitter may be a short-range radio transmitter, although this is not necessary as the display system can also now receive the information through its Internet connection. As shown in FIG. 6, the Internet connection is, in this embodiment, preferably, in a centralized media server 600, which serves a plurality of display units 101. Each display unit includes a touch-sensitive display which forwards the selection parameters, such as the above triplet, to the centralized media server. Based on this information, the media server determines the corresponding URI and the possible service parameters and transmits them, possibly together with the selection parameters, to the mobile terminal.

In a further embodiment of the invention, the display system does not send the URI and the parameters to the mobile terminal but instead forwards the information to a network-based push agent 602, which initiates a process during which the new content is pushed to the mobile terminal 105 from the location referred to in the information, such as from server 314 shown in FIG. 6. The new content can therefore be pulled by the mobile terminal 105, as described in connection with FIG. 3, or pushed by an agent 602 in the network. The service-related information may also be transmitted from the display system directly to the service application. However, an agent can be provided with a functionality which synchronizes the display of the mobile terminal with the external display. In this way, the complexity of the synchronized use of two displays can be hidden from the actual service application. An agent can be shared by a plurality of users or the agents can be user-specific. If the terminal transmits its identity, together with the URI received from the network, to the display system, the display system can send the information to the correct agent.

The user may also make several selections on the screen, whereby the display system determines a coordinate pair for each point indicated. The display system may further determine a selection moment for each point indicated or a common selection time for all the selections. An example of this kind of application could be breakfast or lunch service, where the user first selects a plurality of items and then indicates, by touching a finish button, for example, that the buying event has ended. In this case a list of coordinate pairs is thus determined. In a more sophisticated system this kind of a list may even describe a single user input, such as the signature of the user.

The media server 600 may also serve as a Wireless Local Area Network (WLAN) access point, for example, whereby the mobile terminals may also be portable computers, PDA equipment, intelligent phones or other WLAN-compatible devices such as multimode radio cards, which are also becoming more and more common in user devices. Having his or her mobile terminal equipped with a multimode radio card, the user can choose the network type most suitable in each case, i.e. the user can choose whether the services are accessed through the GPRS or WLAN, for example. However, it is to be noted that the display system of the invention can be utilized for the service session regardless of the particular technology used to access the services.

As obvious from the above, the configuration of the mobile terminal depends on how the display system interacts with its neighborhood. If the new content is pushed to the terminal, the invention does not necessarily cause any modifications in known terminals.

Although the invention was described above with reference to the examples shown in the appended drawings, it is obvious that the invention is not limited to these, but may be modified by those skilled in the art without departing from the scope and spirit of the invention. For example, various short-range communication systems may be used between the display and the terminal. Such a system may be a Bluetooth-based system, a UWB (Ultra Wide Band) based system, or an infrared link, for example. The way in which the service objects are shown on the display can also vary in many ways, and service objects belonging to more than one service may be displayed simultaneously. Furthermore, various current and future display technologies may be utilized in the display unit; the display unit may even include electronic paper.

1. A method for providing services in a communication system comprising user-operated mobile terminals, the method comprising the steps of:
displaying information concerning a service on a screen of a display unit external to a mobile terminal, the information including service objects wherein a user can select at least one service object;
in response to a selection made by a user, defining selection parameters describing the selection;
based on the selection parameters defined, determining service-related information, wherein the service-related information includes at least a resource identifier referring to a location of said service in a communication system;
transmitting a service request to said location;
forming new service content on the basis of the service request; and
transmitting the new service content to the mobile terminal.

2. A method according to claim 1, further comprising the step of sending the service-related information to the mobile terminal, whereby said service request is transmitted from the mobile terminal.

3. A method according to claim 1, further comprising the step of sending the service-related information to an agent in a network, whereby said service request is transmitted from said agent.

4. A method according to claim 1, wherein the selection is made by touching the at least one service object selected on the screen of the display unit, wherein the at least one service object selected on the screen represents at least one point touched.

5. A method according to claim 4, further comprising the step of defining coordinates for the at least one point touched.

6. A method according to claim 5, wherein the defining step further includes defining at least one moment indicating a time of the selection.

7. A method according to claim 2, wherein the sending step further includes sending the selection parameters to the mobile terminal.

8. A method according to claim 3, wherein the sending step further includes sending the selection parameters to the agent.

9. A display system for a communication system comprising user-operated mobile terminals, the display system comprising:
a display unit for displaying information concerning a service provided in a communication system, wherein the information includes service objects, wherein a user can select at least one service object;
user-operated selection means for selecting the at least one service object;
first determination means, responsive to the selection means, for determining selection parameters, wherein the selection parameters describe a selection made by a user;
second determination means for determining service-related information corresponding to the selection parameters, wherein the service-related information includes at least a resource identifier referring to a certain location in the communication system; and
transmission means for transmitting the service-related information to the communication system.

10. A display system according to claim 9, wherein the selection means include a touch-sensitive screen in the display unit.

11. A display system according to claim 10, wherein the first determination means are further configured to define coordinates corresponding to service objects touched by the user.

12. A display system according to claim 9, wherein the first determination means are further configured to define a moment in time when the selection is made by the user.

13. A display system according to claim 9, wherein the transmission means comprise a short-range transmitter.

14. A display system according to claim 9, further comprising at least one agent in a communication network, wherein the transmission means are configured to transmit the service-related information to a selected agent.

15. A display system according to claim 9, wherein the transmission means are configured to transmit the selection parameters to the communication system.

16. A display system for a communication system comprising user-operated mobile terminals, the display system comprising:
a display unit for displaying information concerning a service provided in a communication system, wherein the information includes service objects, wherein a user can select at least one service object;
a touch-sensitive interface, included in said display unit, for selecting the at least one service object;
a control unit, responsive to a user interacting with said touch-sensitive interface, for determining selection parameters, wherein the selection parameters describe a selection made by the user;
a data repository for determining service-related information corresponding to the selection parameters, wherein the service-related information includes at least a resource identifier referring to a certain location in the communication system; and
a transmitter for transmitting the service-related information to the communication system.

17. A display system according to claim 16, wherein the touch-sensitive interface comprises a touch-sensitive screen in the display unit.

18. A display system according to claim 17, wherein the control unit is further configured to define coordinates corresponding to service objects touched by the user.

19. A display system according to claim 16, wherein the control unit is further configured to define a moment in time when the selection is made by the user.

20. A display system according to claim 16, further comprising at least one agent in a communication network, wherein the transmitter is configured to transmit the service-related information to a selected agent.

21. A display system according to claim 16, wherein the transmitter is configured to transmit the selection parameters to the communication system.
